(19) United States
(12) Patent Application Publication
(10) Pub. No.: US 2026/0094778 A1
(43) Pub. Date: Apr. 2, 2026

(54) ROTARY CONTROL KNOB

(71) Applicant: Balboa Water Group, LLC, San Diego, CA (US)

(72) Inventors: Raymond Carr, Lutz, FL (US); Sean Carr, Lutz, FL (US); Casey Bollig, Rio, WI (US)

(21) Appl. No.: 19/339,169

(22) Filed: Sep. 24, 2025

Related U.S. Application Data
(60) Provisional application No. 63/700,424, filed on Sep. 27, 2024.

(51) Int. Cl. H01H 36/00; H01H 19/14

(52) U.S. Cl. CPC H01H 36/0073; H01H 19/14

(57) ABSTRACT

A rotary knob control system includes a rotating knob assembly and a static stem receiver including a receptacle configured to receive the rotating assembly. A suspension system is configured to suspend the rotating assembly within the receptacle and to allow rotational movement of the rotating assembly. A sensor system is configured to generate electrical signals indicative of position and movement of the rotating assembly within the receptacle.

This application claims priority to provisional Application No. 63/700,424, filed Sep. 27, 2024.

### BACKGROUND OF THE APPLICATION

This invention is directed to user interface devices, and more particularly to rotatable control knobs. The control knobs provide signals representative of rotational manipulation of the knob as well as, in some embodiments, pressing and/or pulling the knob.

### BRIEF DESCRIPTION OF DRAWINGS

Features and advantages of the disclosure will readily be appreciated by persons skilled in the art from the following detailed description when read in conjunction with the drawing wherein:

FIG. 1 is an isometric view of an exemplary embodiment of a rotary knob assembly in accordance with aspects of the invention.

FIG. 2 is an exploded view of the rotating assembly and the stem receiver structure of the rotary knob assembly of FIG. 1.

FIG. 3 is an exploded cutaway view of the rotating assembly and the stem receiver structure of FIG. 2.

FIG. 4A illustrates the rotating assembly and stem receiver structure as in FIG. 3, with the rotating assembly in assembled position within the stem receiver structure. FIG. 4B is similar to FIG. 4B, but showing the rotating assembly in a depressed position within the stem receiver structure. FIG. 4C illustrates an exemplary embodiment of the rotary knob and a wiring set for connection to a port in the rotary knob assembly.

FIG. 5 is an exploded view of components of the rotary knob assembly of FIG. 1. FIG. 5A is a diagrammatic view of an exemplary embodiment of the circuit board and sensor of the sensor module of the rotary knob assembly.

FIG. 6 is an isometric view of portions of two pairs of magnet rings in isolation.

FIG. 7 is a diagrammatic representation of a pair of magnet rings.

FIG. 8A illustrates a series of coils for an alternate sensor embodiment.

FIG. 8B illustrates an exemplary metal pattern for the sensor embodiment with the series of the coils of FIG. 8A.

FIG. 9A illustrates an exemplary embodiment of a schematic block diagram of the sensor module. FIG. 9B is an exemplary flow diagram of exemplary processing performed by the sensor module.

FIGS. 10A and 10B illustrate a cutaway view and a top view respectively of an alternate embodiment of a rotary knob assembly with dual knobs.

FIG. 11 illustrates an exemplary embodiment of a control knob system using a mechanical support system.

### DETAILED DESCRIPTION OF THE INVENTION

In the following detailed description and in the several figures of the drawing, like elements are identified with like reference numerals. The figures may not be to scale, and relative feature sizes may be exaggerated for illustrative purposes.

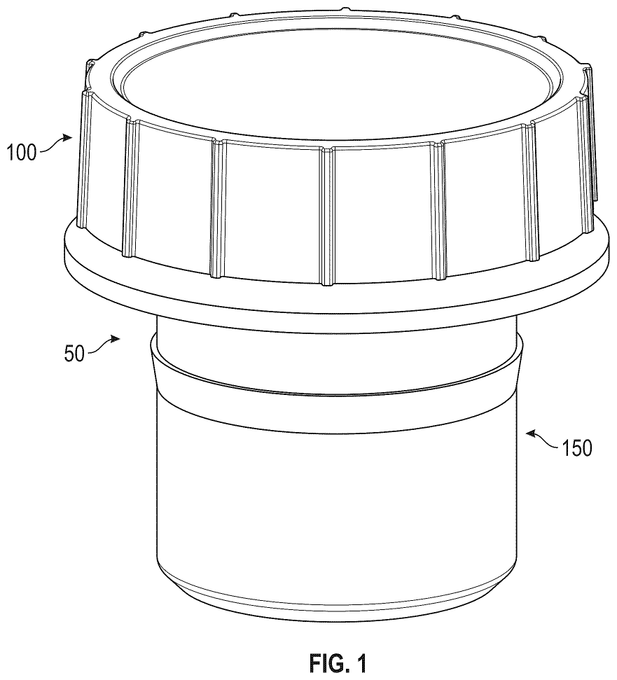

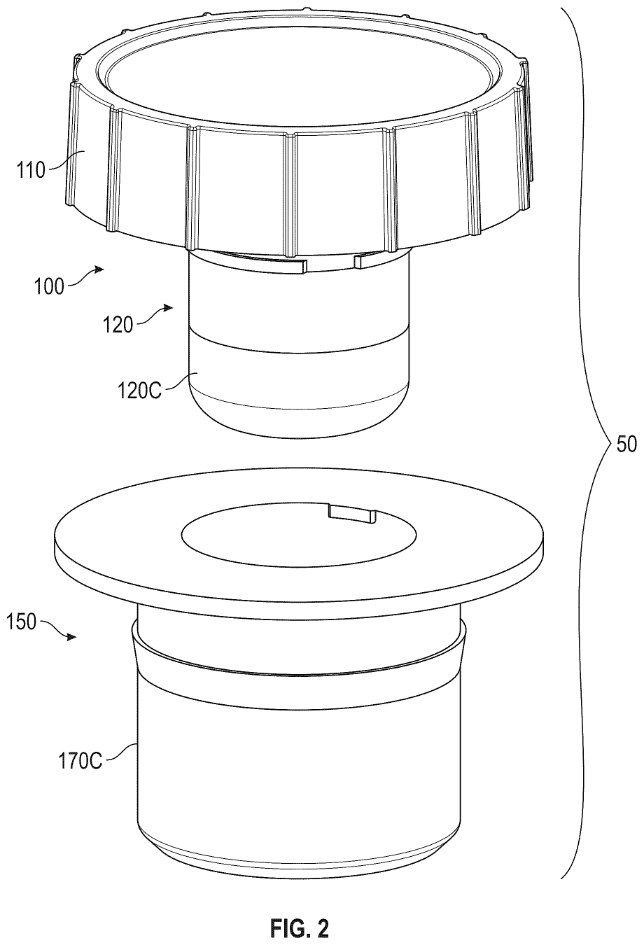

Referring to FIGS. 1-8B, exemplary embodiments of a rotary knob control system 50 in accordance with aspects of the invention include several components that work together to provide both rotational control and additional functionalities, such as pressing and/or pulling. The rotary control knob system in exemplary embodiments provide a waterproof control system. The main components include a rotating assembly 100 and a stem receiver 150 including a stem receiver structure 170A. A locking rib mechanism 140, 154 is provided to retain the rotating assembly within the stem receiver while allowing removal at a specific orientation. The stem receiver structure 170A is a single unitary molded piece that has no holes or gaskets that allow for water ingress into the knob stem electronics module 180. This control system uses electromagnetic (EM) field coupling between the stem and the module to detect a rotation or press, so a physical interface is not needed, thus eliminating the need for a hole and seal.

### Rotating Assembly:

The rotating assembly forms the interactive part of the knob, which the user manipulates to control various system parameters. The rotating assembly includes an aesthetic knob 110, i.e. the outer portion that the user interacts with, designed as the “mushroom cap” of the knob. This knob can either be permanently fixed to the stem or made interchangeable, allowing for different aesthetic options.

The rotating assembly also includes a stem structure 120, resembling the “mushroom stem,” which connects to the aesthetic knob 110. In an exemplary embodiment, the stem 120 houses two inner rings 130, 132 of magnets with specific polarizations, which create tactile feedback during rotation. The interaction of the inner magnet rings with the outer magnet rings creates tactile feedback during rotation, as well as to keep the knob suspended, like polarized magnets resist each other, to give the user some resistance, then when turned far enough they are now closer to the attracting magnets and it snaps to alignment, yielding the tactile feedback of a spring detent with no spring. At the base of the stem, a diametrically polarized magnet 134 in one embodiment or a patterned metal component in another embodiment is located to interact with the sensing mechanism.

### Stem Receiver:

The static part of the rotary knob assembly is a stem receiver structure 150, which defines a well or receptacle 152 that securely houses the stem and enables its rotation and additional movements. Features of the stem receiver structure 150 include:

Magnetic Suspension: In one exemplary embodiment, the stem structure 120 is magnetically suspended within the well 152 of stem receiver 150, allowing for smooth rotational movement without direct mechanical contact. This design helps reduce wear and maintain consistent performance over time.

Magnetic Rings: Located around the outside walls of the stem receiver structure 150, these larger magnetic rings 160, 162 correspond to the rings 130, 132 in the stem structure 120. This arrangement ensures the necessary magnetic interaction for tactile feedback while maintaining separation between the rotating and static components. The magnetic rings may be fabricated from individual magnet pieces or segments, or as an integral one-piece magnet.

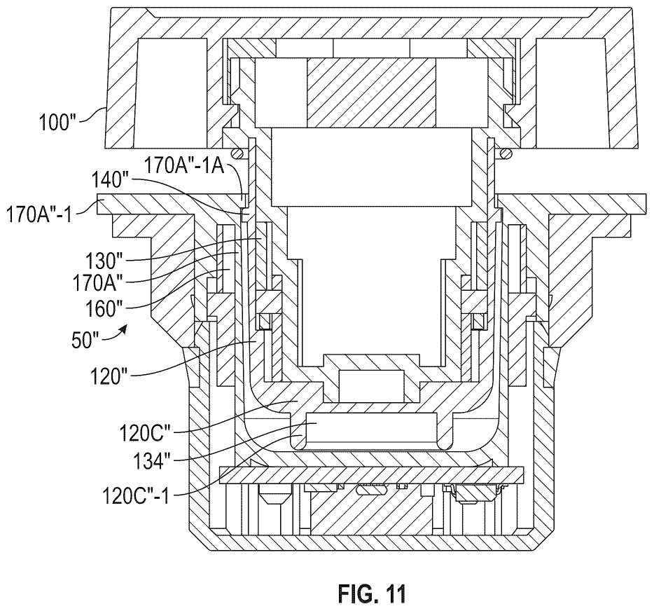

In another embodiment in which the knob is configured for rotation without the capability of push or pull movements, the knob structure may utilize mechanical support, and the magnetics will provide haptic feedback to the user. This alternate embodiment would still provide a waterproof control knob system, that can be used more like an amplitude or volume control without a selector function. In this embodiment, the knob would just ride in a track, bushing or rib to keep it in place like any other knob, but the tactile response would be from a sigle pair of magnet rings. FIG. 11 illustrates an exemplary embodiment of a control knob system using a mechanical support system.

Sensor Electronics: Positioned at the bottom of the stem receiver, on the outside, is the electronics module 180 responsible for detecting the rotation of the stem. The electronics module 180 includes a sensor system, which in exemplary embodiments can be magnetic or inductive, to detect the rotation through the material of the well without direct exposure to the environment.

### Locking Rib Mechanism:

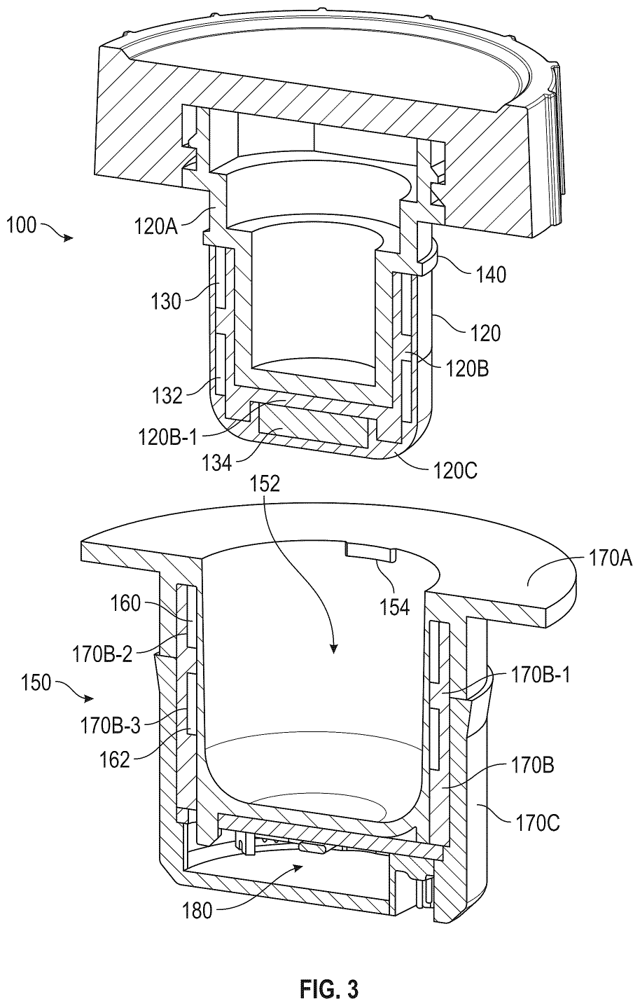

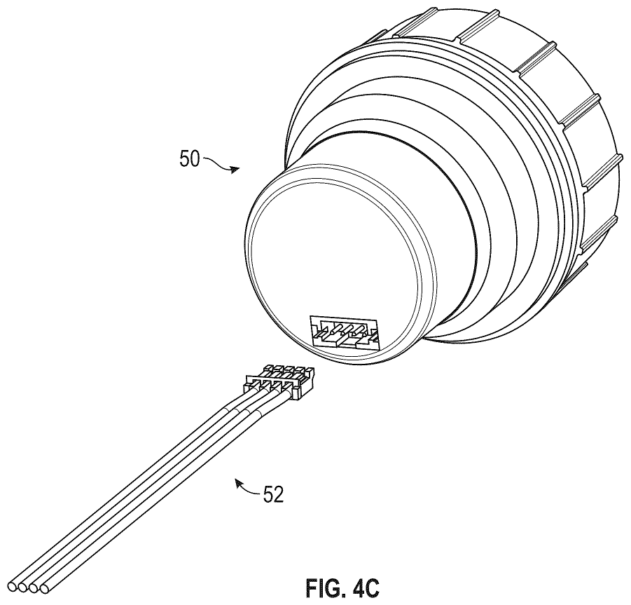

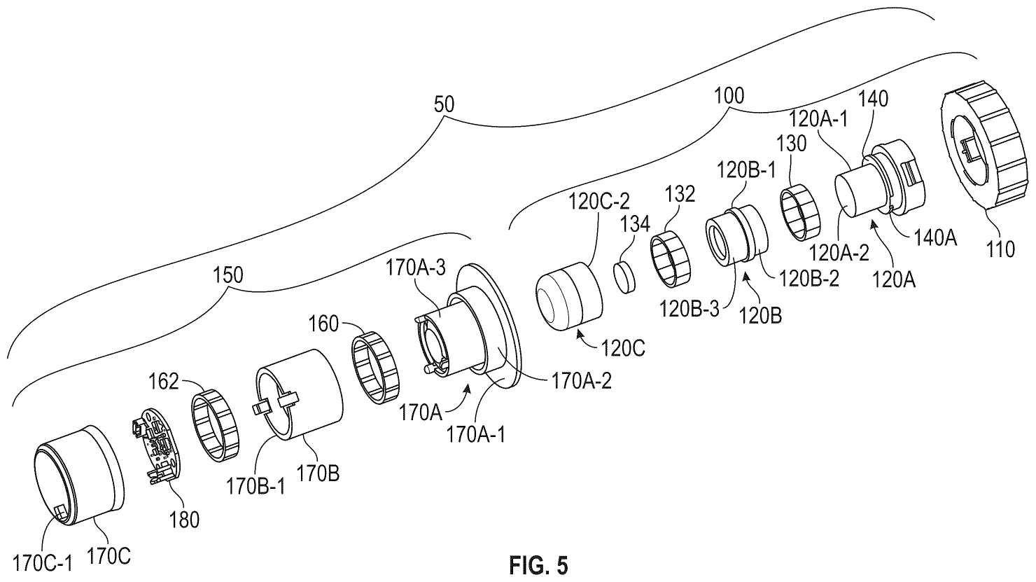

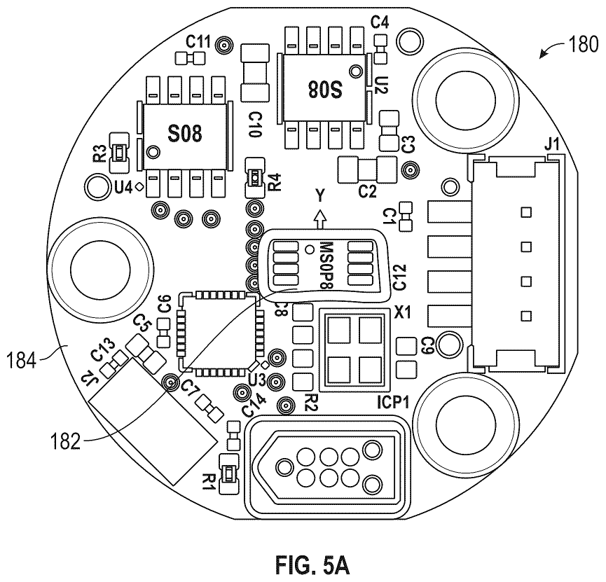

To prevent unintended removal of the rotating knob 100 from the receiver 150, a locking rib mechanism is integrated into the design of the rotatable knob assembly 50. This mechanism ensures that the knob can only be removed intentionally by the user, adding an additional layer of control. The locking rib mechanism includes circumferential rib 140 protruding from stem housing 120A; the rib 140 has an open region 140A (FIG. 5) that allows the rib 140 to pass projection 154 (FIG. 3).

The stem structure 120 includes a circumferential rib 140 that engages with a corresponding projection 154 in the stem receiver structure 170A. This rib prevents the knob from being removed unless it is rotated to a specific, predetermined position. This design ensures that the knob remains securely attached during normal operation but can be removed intentionally when necessary.

The rotary knob control system may be configured to allow both pressing and pulling movements in addition to rotation. The locking rib is placed higher on the stem receiver structure with respect to the magnetics to allow for pulling movements. The locking rib mechanism does not interfere with these movements, enabling the knob to function as a multi-functional control device. Pressing and pulling actions are accommodated by the design of the stem 120 and receiver structure 150, allowing for additional input options. Because the knob 100 is magnetically suspended, in the center point (where the forces are balanced), the magnetic forces pull the knob back to the center position. If the user presses down on the knob, the electronics module can measure how much it moves down or simply detect that as a press. Alternatively, if the user pulls on the knob 100 by grasping the edges, the user can pull it out partway (or remove the knob completely if desired). The electronics module, e.g., with a Hall effect sensor, can detect that motion and either measure the displacement distance or register a pull event.

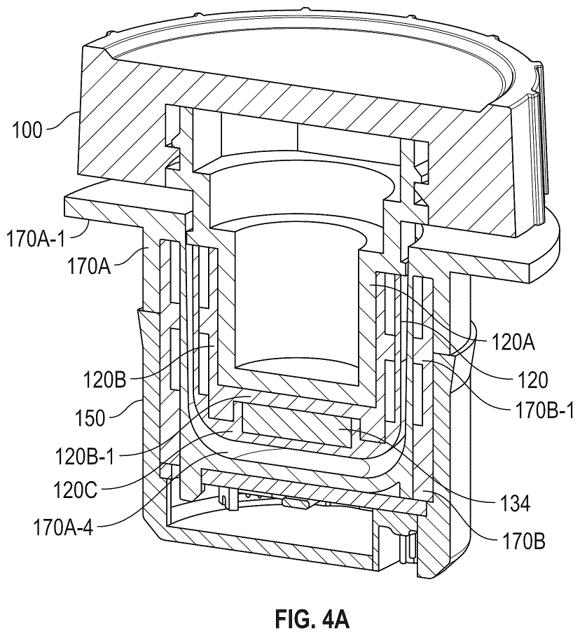

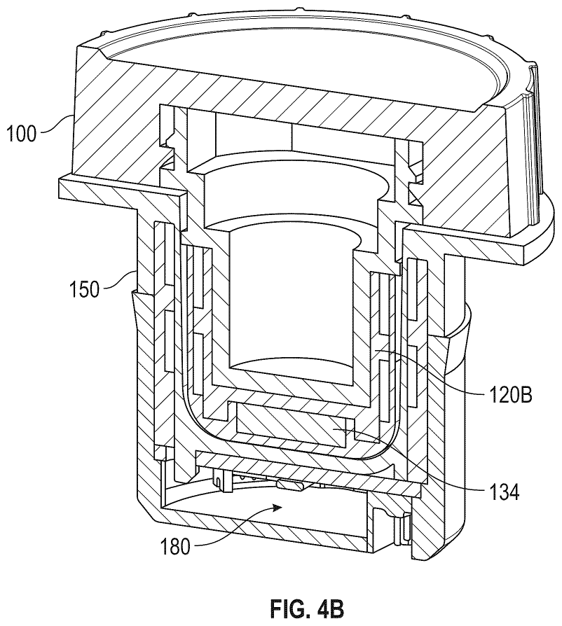

FIG. 4A shows the stem 120 in the rest position within the well of the receiver structure, suspended so that the bottom magnet 134 mounted to the bottom surface 120B-1 of stem middle housing 120B is above the adjacent bottom surface 170-4 of stem housing structure 170A. FIG. 4B shows the stem structure 120 in a depressed position with the bottom magnet 134 closer to the electronics module 180 in the stem receiver structure 150.

As previously described, in an exemplary embodiment, the rotary knob control assembly utilizes a magnetic suspension system that enables smooth, frictionless rotation by suspending the knob magnetically without any mechanical support. This system allows the knob assembly 100 to float within the stem receiver 150, functioning effectively in air, liquid, or even a vacuum.

The magnetic suspension system in an exemplary embodiment includes two sets of magnet rings, an inner set of magnet rings 130, 132 and an outer set of magnet rings 160, 162. The inner magnet rings are located within the stem 120, and the outer magnet rings are positioned in the stem receiver 150. Each magnet ring set includes a top magnet pair and a bottom magnet pair, with the corresponding inner and outer sets designed to attract each other within their respective pairs.

FIG. 5 is an exploded isometric view of components of an exemplary embodiment of the rotary knob control system 50. The knob assembly 100 includes the ascetic knob 110, which mechanically attaches to hollow stem housing 120A, e.g. by barbed fittings, or other means such as adhesive. The stem housing 120A has a cylindrical surface 120A-1, onto which is fitted magnet retainer 120B. The bottom surface 120A-2 of the stem housing carries the base magnet 134.

The retainer 120B has cylindrical outer surfaces 120B-2 and 12B-3, separated by peripheral protruding rib 120B-1. Magnet ring 130 is fitted about the cylindrical outer surface 120B-2. Magnet ring 132 is fitted about the cylindrical outer surface 120B-3. A hollow cover structure 120-C is fitted over the retainer structure and magnet rings, and its top edge abuts the bottom surface of the rib 140. The cover structure may be secured in place with adhesive or by mechanical fasteners.

The stem housing 120A, the retainer 120B and the cover structure 120C may be fabricated of a non-magnetic material such as a plastic material.

Still referring to FIG. 5, the receiver assembly 150 includes hollow stem receiver housing 170A which includes a flange portion 170A-1, a skirt portion 170A-2 and a cylindrical portion 170A-3. The skirt portion 170A-2 defines a recessed region between the skirt and the cylindrical portion. A receiver magnet retainer 170B is a hollow structure with an internal rib 170B-1 protruding inwardly, and internal recessed regions 170B-2 and 170B-3 formed on either side of the internal rib. The housing 170A and retainer 170B are fabricated of a non-magnetic material, such as plastic. The magnet rings 160 and 162 are fitted into the respective internal recessed regions (FIG. 3). The retainer 170B is fitted over the cylindrical portion 170A-3, extending into the recessed region between the skirt and cylindrical portion.

The electronics module 180 in an exemplary embodiment includes a circuit board 184 on which the sensor 182 is populated, as illustrated in FIG. 5A. In this exemplary embodiment, the sensor is a Hall effect 3D sensor. The module 180 is fitted against the bottom surface 170B-1 of the receiver retainer structure. A cover 170C is fitted over the receiver retainer structure 170B and seated against the base of the skirt 170A-2 of the stem receiver housing 170A. Electrical communication with, and power to, the sensor module 180 may be provided by wiring 52 (FIG. 4C connecting to port 170C-1 of the cover.

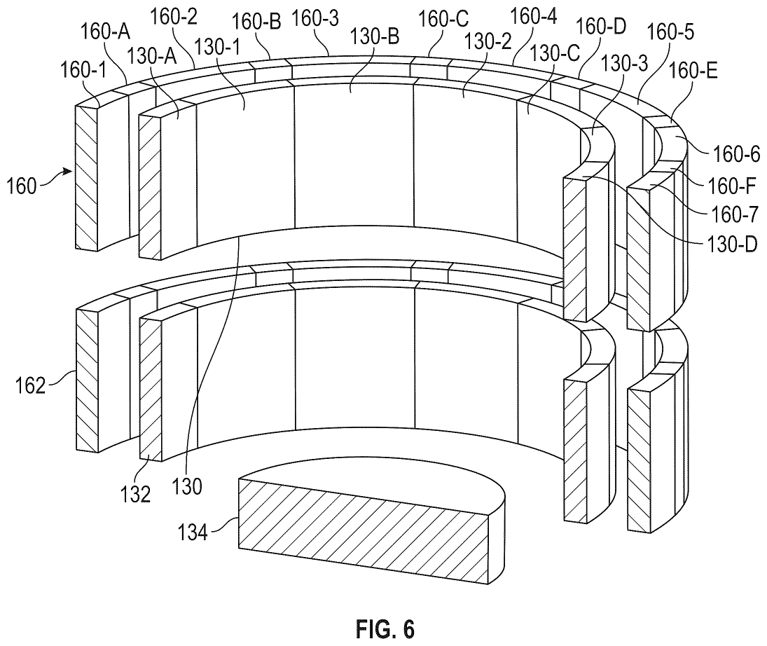

FIG. 6 is a diagrammatic view showing a truncated portion of the two sets 130, 160 and 132, 162 of magnet rings and the bottom magnet 134. The top and bottom pairs of magnet rings interact with each other, with opposing polarities creating repulsive forces between the top and bottom sets.

An exemplary embodiment of this rotary knob system is as follows:

Top Pair 130, 160:

Outer Top Ring 160: In the stem receiver 150, with a North (N) polarization on its inner diameter (ID).

Inner Top Ring 130: Within the stem 120, with a South(S) polarization on its outer diameter (OD).

Bottom Pair 132, 162:

Outer Bottom Ring 162: In the stem receiver 150, with a South(S) polarization on its inner diameter (ID).

Inner Bottom Ring 132: Within the stem 120, with a North (N) polarization on its outer diameter (OD).

The inner and outer rings provide magnetic interaction, in that the inner and outer rings in each pair attract each other, while the top and bottom pairs have opposite polarities, resulting in repulsion between the top and bottom rings. This setup ensures smooth rotational movement and stable positioning of the stem 120 within the receiver 150.

The rotary knob incorporates a self-correcting mechanism within the magnetic suspension system. This feature ensures that if the knob is displaced from its nominal position, it automatically returns to its intended alignment. The self-correcting capability arises from the combination of attractive and repulsive magnetic forces.

### Mechanism of Self-Correction:

The knob structure 100 is suspended by both attractive and repulsive forces between the inner and outer rings 130, 160 and 132, 162. The system is designed so that the forces act together to correct any displacement from the nominal position.

The inner magnet rings within the stem and the outer magnet rings in the stem receiver create both attractive and repulsive magnetic interactions:

The inner and outer rings in each magnet pair attract each other, which helps stabilize the knob in its central position. Thus, in this exemplary embodiment, the magnets of the respective rings 130, 160 attract each other, and the magnets of the respective rings 132, 162 attract each other. In one embodiment, the magnet rings are fabricated from separate magnet pieces. In another embodiment, the magnet rings may be fabricated using a method as a stepper motor rotor, such as described, for example, in “Dynamic Analysis of Permanent Magnet Stepping Motors, David J. Robinson, NASA Technical Note TN D-594 March 1969; That is, the rings are manufactured essentially as blanks and the magnetism is applied through a fixture specific to the geometries desired for the specific application. These geometries may be changed depending upon the user's desire for position, if any, of the haptic “clicks”

The top and bottom pairs of magnet rings (130, 132 and 160, 162) have opposing polarities, to allow the knob 100 to return to the “at rest” position, axially. The two ring sets are in a state of attraction at rest, but when the user presses the knob down, repulsive forces are created by changing the alignment vertically.

### Self-Correcting Dynamics:

When the knob structure is axially displaced from its nominal position, the distance between the inner and outer rings changes. According to the inverse square law, the magnetic force varies with the square of the distance between the magnets.

If the inner rings 130, 132 move lower in relation to the corresponding outer rings 160, 162, the attractive force weakens with increased distance. However, because the system also includes repulsive forces, as the inner ring 130 approaches the outer ring 162, the repulsive force increases.

The repulsive force increases faster than the attractive force decreases due to the inverse square law. This creates a self-correcting effect: as the inner rings move further from their nominal position, the repulsive force grows stronger, counteracting any further axial displacement and guiding the knob back to its central position.

An embodiment of the rotary knob 50 may incorporate magnetic detents as an optional feature to provide distinct positional feedback during rotation. This feature is not required for smooth, continuous rotation but can be included for applications where tactile feedback at specific positions is desired.

To enable magnetic detents, the magnetic rings are divided into segments. These segments interact to create noticeable resistance and alignment cues as the knob rotates. The segments are created by spacing the magnets of each ring apart from adjacent magnets. FIG. 6 illustrates the segments, in which the magnets 130-1, 130-2, 130-3 of partial upper inner ring 130 are separated by non-magnetic spacers, 130-A, 130-B, 130-C, 130-D. The magnets 160-1, 160-2, 160-3, 160-4, 160-5, 160-6 of partial upper outer ring 160 are separated by non-magnetic spacers 160-A, 160-B, 160-C, 160-D, 160-E. The lower magnetic rings 132, 162 are segmented in the same manner. In this exemplary embodiment, there are twice as many spaced magnets in the outer rings as in the inner rings. The number of magnets on the outer rings is driven by the amount of non-magnetic rotational distance needed to cause the correct detent feel. The magnitude/feel of the detent may be raised or lowered by decreasing or increasing the number of magnets on the outer rings.

When the knob structure 100 is in its neutral position, as depicted in the diagrammatic view of FIG. 7, the magnet segments of the inner rings align with corresponding segments of the outer rings. In this alignment, the magnetic attraction (indicated as arrow A in FIG. 7) between the aligned segments (such as magnets 130-2 and 160-2) is strongest, providing resistance to rotation.

Rotation Feedback: As the knob structure 100 is rotated, say in the direction indicated by arrow C in FIG. 7, the inner ring segments move away from the aligned position and approach the next set of outer ring segments. The magnetic attraction (indicated as arrow B in FIG. 7) between the approaching segments (e.g., 130-2, 160-1) increases, pulling the knob structure 100 into the next position and creating a distinct detent feeling.

The transition between segments provides clear feedback to the user, allowing them to feel each detent position as the knob is turned. This can be useful for applications where precise adjustments are needed, such as setting specific temperature levels or volume settings.

### Rotational Sensing

The rotary knob system 50 incorporates advanced rotational sensing technologies to accurately detect and measure the knob's position and movement. In exemplary embodiments, this is achieved through the use of a 3D Hall effect sensor or an inductive sensor, each paired with specific sense elements for precise data acquisition.

### Sensing Components

### Magnetic Sensor:

A 3D Hall effect sensor 182 is combined with a diametrically polarized magnet 134 positioned adjacent the bottom of the stem structure 120. The 3D Hall effect sensor measures the total magnetic flux and the vector of the flux. By detecting the North-South orientation of the diametrically polarized magnet 134, the sensor can determine the angle of rotation through simple geometric calculations, the sensor 182 may typically include a processor to implement the geometric calculations, for example to calculate angles about the xy, yz, zx planes. However, more complex motions may typically be processed with a host microcontroller, i.e. the microcontroller of the host system utilizing the control knob 50.

The sensor detects changes in the magnetic field caused by the movement of the stem's magnet, allowing it to measure both the distance from the sensor and the angle of rotation. In an exemplary embodiment, the 3D Hall sensor measures the magnetic flux density vector (B) in three axes (X, Y, Z). What we care about is how that vector changes in 3D space as the magnet moves. By tracking both the direction and the magnitude of B, we can back out the magnet's location and orientation relative to the sensor.

In practice that gives us nine degrees of freedom:
Three raw field components (B_x, B_y, B_z).
Three axes of rotation (how the vector points as the magnet twists or tilts).
Three axes of translation (how the vector's strength shifts as the magnet moves closer, farther, or sideways).

With those, we can figure out specific motions:
Rotation (twist): As the magnet spins around its vertical axis, the field direction in the X-Y plane rotates. The sensor sees this as the vector sweeping around, which maps directly to angular position.
Distance (push/pull): Moving the magnet closer or farther changes the overall field strength. Stronger means closer, weaker means farther, giving us press or lift detection.
Tilt (joystick lean): Tilting the magnet tips the field vector out of the X-Y plane and adds a Z component. The sensor detects this shift and resolves the tilt angle and direction.
Translation (slide in plane): Shifting the magnet sideways in X or Y changes the balance of field strength across axes. This uneven change reveals lateral movement.
Complex motion (combined moves): In real use, these motions often overlap. Twist, push, tilt, and slide can all occur together, and the sensor simply measures the resulting B-vector. Interpreting that combined signal is heavy vector math in 3D space, where software separates the overlapping degrees of freedom.

In short, by watching how the B-vector evolves, the system can detect rotation, distance, tilt, translation, or any combination—all with a single magnet and sensor, and no mechanical contact required.

### Inductive Sensor:

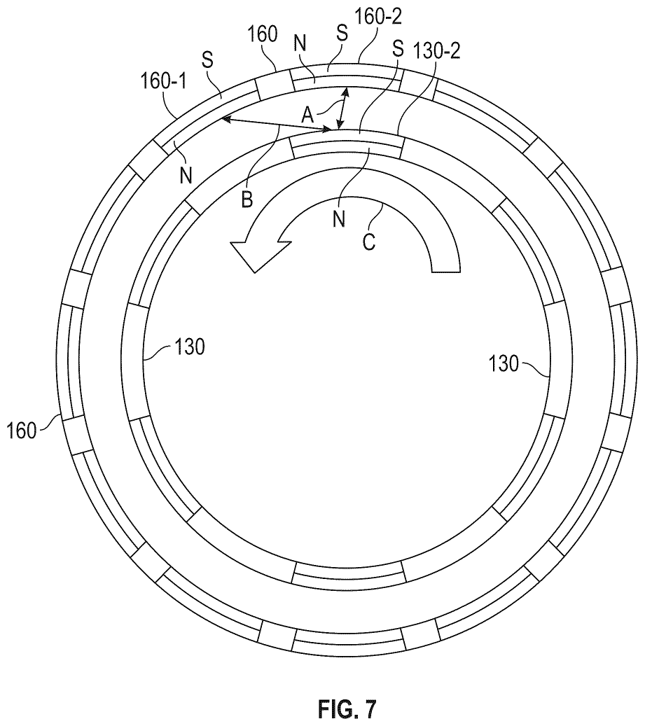

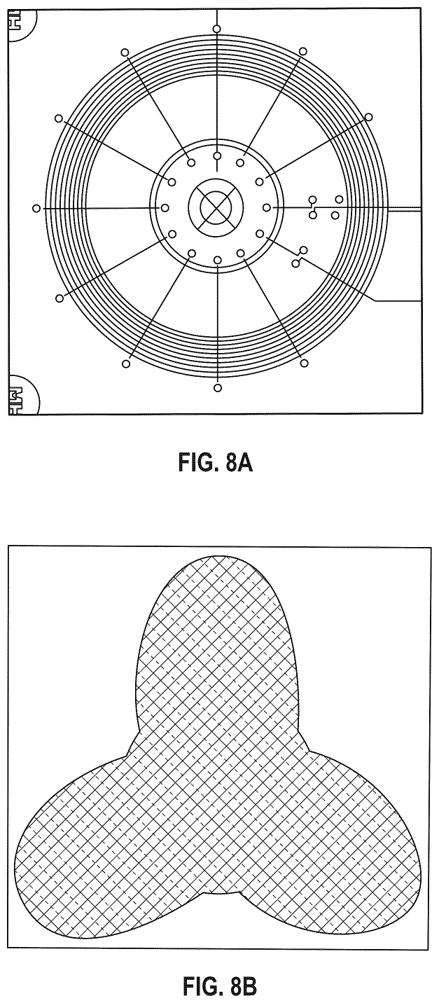

A series of coils (FIG. 8A) are defined in the electronics module and an metal pattern (FIG. 8B) is formed on the bottom of the knob stem 120. The sensor includes an excitation source for the coils. In an exemplary embodiment, a microcontroller generates an AC wave necessary for inducing currents in the metal pattern. By measuring the inductive coupling between the coils and the pattern, the sensor determines the angle of rotation. The total inductive coupling also provides information on the distance between the sensor and the metal pattern.

Variations in inductive coupling are used to calculate the angle of rotation and, based on the coupling strength, the distance from the sensor.

### Data Conversion

The measurements from these sensors, i.e. either the sensor system utilizing a 3D Hall effect sensor or the sensor system utilizing a series of coils and metal pattern, are converted into digital signals that represent various types of knob interactions:

Movement: Rotation around the Z-axis.

Press and Pull: Detection of pressing and pulling actions.

Clicks: Feedback for discrete rotational steps or detents.

Displacement: Measurement of relative or absolute displacement of rotation.

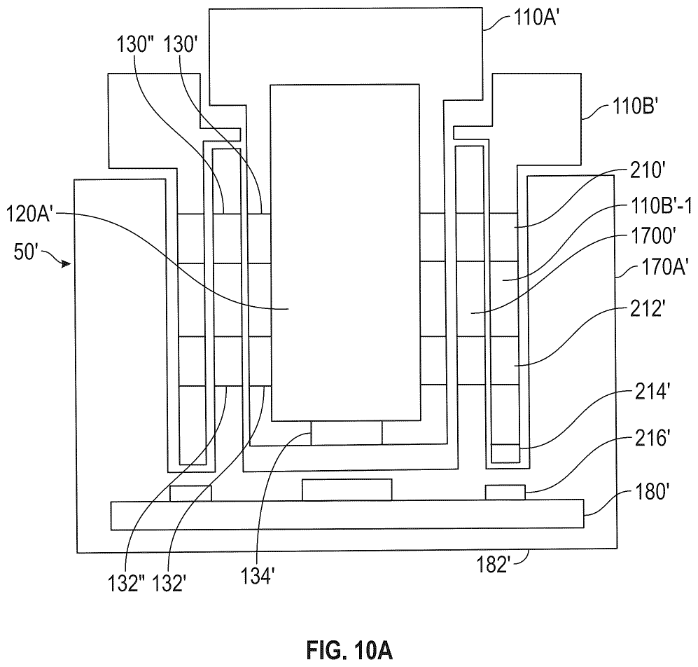

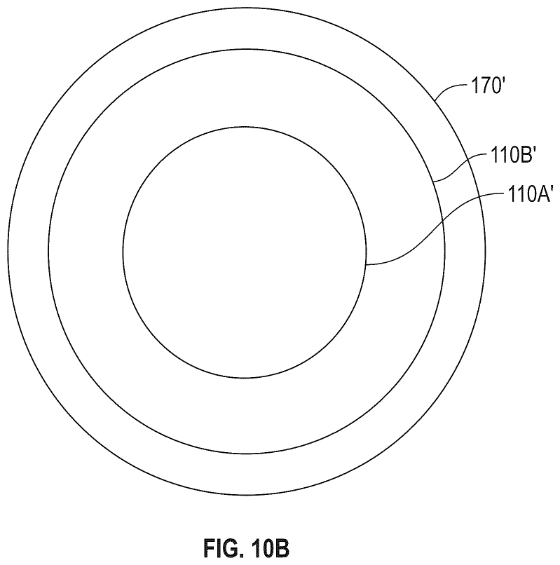

These data points are processed to provide precise control inputs for various applications, including, without limitation, speed control of a spa pump, per seat massage intensity control, light intensity and/or color selection for a light controller, salt generator output value adjustment, volume adjustment for audio w/mute, for the dual selector embodiment (FIGS. 10A, 10B described below), the outer selector may be used for forward/backward page selection on the UI, and the inner selector used for parameter selection and value adjustment, and for the dual selector embodiment, the outer selector may be used for forward/backward song skipping/selection, and the inner selector used for mute and volume adjustment.

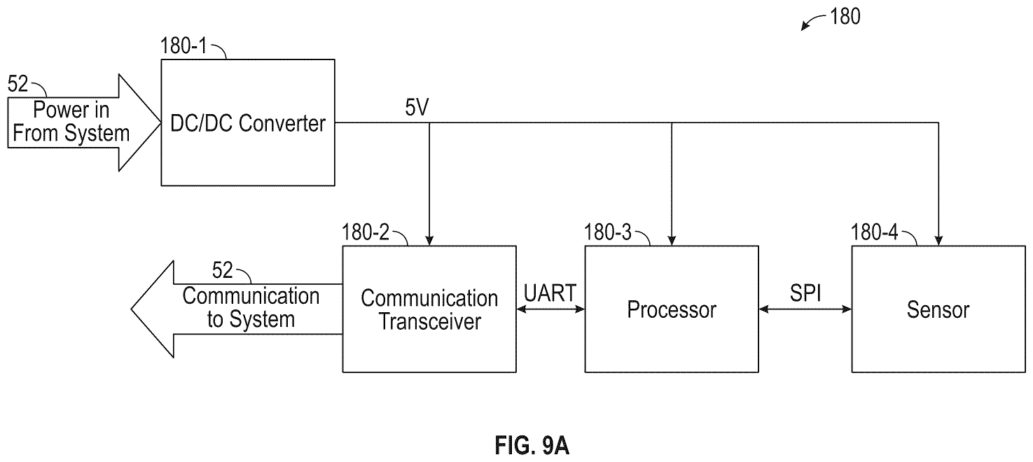

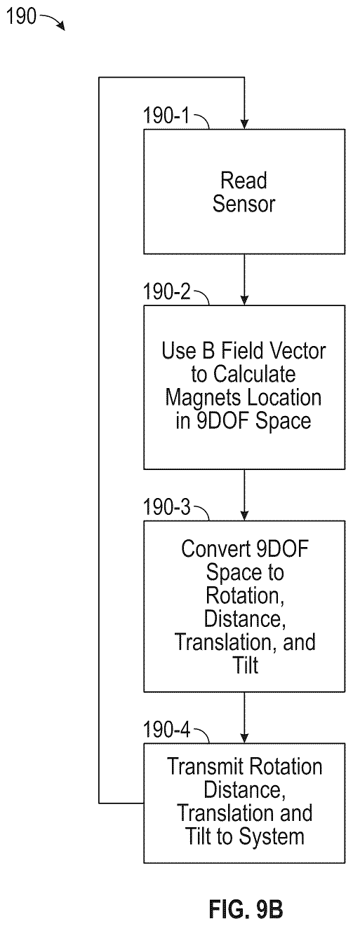

FIG. 9A illustrates an exemplary embodiment of a schematic block diagram of the sensor module 180. Power is brought in through wiring 52 to a DC/DC converter 180-1, which in turn provides 5V power to the communication transceiver 180-2, the processor 180-3 and the sensor 180-4. The sensor may be a magnetic sensor or an inductive sensor as described above.

FIG. 9B illustrates an exemplary processing 190 for the sensor module illustrated in FIG. 9A. At 190-1, the sensor is read. At 190-2, the B field vector is used to calculate the magnets location in 9 degrees-of-freedom (9DOC) space. At step 190-3, the 9DOF space is converted to rotation, distance, translation, and tilt. At 190-4, the module transmits the rotation, distance, translation and tilt to the system utilizing the control knob.

FIGS. 10A and 10B illustrate another embodiment of the control knob assembly 50′ where an outer rotating knob 110B′ has been added to supplement the selector (inner) knob 110A′. The inner knob (rotor) 110A′ is magnetically suspended by the static magnet rings 210′ and 212′ in an inner cylindrical structure 170D′ of the housing 170A′. As well, the outer rotating knob 110B′ includes a cylindrical housing 110B′-1 that is fitted between the inner cylindrical structure 170D′ and housing structure 170A′, and is also suspended by the static magnet rings in the housing, with the rings 130″, 132″ of opposite polarity as the magnet rings 130′, 132′ of the inner knob.

The rotary orientation of both the inner and outer knobs 110A′, 110B′ may be sensed using various methodologies. In this exemplary embodiment, the inner knob 110A′ uses a magnetic field Hall effect sensor 182′ for rotary angle and “push” selection. The outer knob 110B′ uses inductive eddy current transmit/receive traces comprising an eddy current sensor 216′ on a PCB 180′ to sense rotary location of the Metal Target 214′.

The control knob assembly 50′ is a variation of the control knob assembly 50 shown in FIGS. 1-8B that provides an inner selector 110A′ and an outer selector 110B′ for UI navigation or for dual controls on speed selection for various controlled devices such as motors. The dual control knob assembly can use either magnetic or inductive sensors; this embodiment uses both. As shown in FIGS. 9A and 9B, the outer knob 110B′ does not push to select (no gap), and just rotates. In other embodiments, the outer knob 110B′ may be configured with a gap to provide a push-to-select function if needed.

As an example of use for this alternate embodiment, the outer knob 110B′ may sequence forward/reverse through UI pages, while the inner knob/selector 110A′ can be configured for use for feature selection and activation on that given page.

Turning now to FIG. 11, an exemplary embodiment of a rotary control knob system 50″ using a mechanical support system to support the knob 100″ for rotational movement, rather than a magnetic system as in the embodiments described in FIGS. 1-10B. The system 50″ is similar to the system 50 described in FIGS. 1-17, for example. Differences include the removal of one set of magnet rings (the lower ring on both the rotary knob 100 and the receiver 150), so that only an inner magnet ring or set of magnets 130″ and one outer magnet ring or set of magnets 160″ is employed. The empty space left from those “removed magnets is accounted for with added material (plastic) from the existing parts. This will aid assembly and tolerance constraints.

A tab 170A″-1A is added to stem receiver structure 170A″-1 so that the locking ring 140″ of the knob 100″ is captured. To fix the knob in the z direction, the stem structure 120″ includes at base 120C″ a boss 120C″-1 that fills the gap. This keeps the overall profile of the system 50″ identical to that of rotary knob system 50 and the rotary knob is rotatable within the stem receiver, but the knob no longer has the means or the room to translate in and out in a pushing motion. Removal of the knob is still intended. The magnet 134″ may be placed within the boss 120C″-1 or as in knob system 50.

The mechanical support system in this embodiment includes the fitment between the outer surface of the stem structure 120″ and the inner surface of the stem receiver structure 170″, the engagement of the locking ring 140″ against the inner surface of the stem receiver structure 170″, the engagement of the boss 120C″-1 against the bottom surface of the stem receptacle structure 170″, and the capturing of the stem structure within the receptacle of the receiver structure by tab 170A″-1A and locking ring 140″.

This alternate embodiment 50″ still provides a waterproof control knob system, in that the stem receiver structure 170A″ is a unitary one-piece molded structure with no opening or seals to admit moisture. The magnet rings will provide haptic feedback to the user. One exemplary type of application of the system is an amplitude or volume control without a selector function. The system employing a mechanical support system for the knob could be modified to allow vertical movement by providing a spring between the knob stem structure and the stem receiver structure to bias the vertical position while allowing vertical movement.

Exemplary applications for the control knob systems described above include, for the spa field, to control spa elements, like temperature, jets, lights, audio, or menu navigation on the control screens.

Although the foregoing has been a description and illustration of specific embodiments of the subject matter, various modifications and changes thereto can be made by persons skilled in the art without departing from the scope and spirit of the invention.

1. A rotary knob control system, comprising:
a rotating assembly, including a knob portion and a stem structure, and one or more inner magnetic rings or sets of magnets supported by and surrounding a periphery of the stem structure;
a static stem receiver including a receptacle configured to receive the stem structure, the stem receiver including one or more outer magnetic rings or sets of magnets disposed around the receptacle;
a suspension system configured to suspend the rotating assembly within the receptacle and to allow rotational movement of the rotating assembly; and
a sensor system configured to generate electrical signals indicative of position and movement of the rotating assembly within the receptacle.

2. The rotary knob control system of claim 1, wherein the knob portion, the stem structure and the receptacle are formed of a non-magnetic material, and the suspension system is a magnetic suspension system configured to suspend the rotating assembly magnetically within the receptacle without mechanical support, the magnetic suspension system comprising the inner and outer sets of magnetic rings or sets of magnets and configured to provide haptic feedback to the user.

3. The rotary knob control system of claim 2, wherein the one or more inner magnetic rings or sets of magnets and the one or more outer magnetic rings or sets of magnets comprise a top pair of inner and outer magnetic rings or sets of magnets and a bottom pair of inner and out magnetic rings or sets of magnets, with the corresponding inner and outer sets designed to attract each other within their respective pairs, while the top and bottom pairs have opposite polarities, resulting in repulsion between the top and bottom rings.

4. The rotary knob system of claim 1, wherein the suspension system includes a mechanical support structure comprising fitment between adjacent surfaces of the stem structure and the static stem receiver to maintain the stem structure within the receptacle while permitting rotational movement, and wherein the sets of magnet rings or sets of magnets include a first inner magnetic ring or set of magnets and a first outer magnetic ring or set of magnets configured to provide haptic feedback.

5. The rotary knob control system of claim 1, further comprising a locking rib mechanism configured to prevent unintentional removal of the rotating assembly from the receptacle, the locking rib mechanism including a rib portion protruding from the stem structure.

6. The rotary knob control system of claim 1, wherein the sensor system comprises:
a diametrically polarized magnet disposed at or adjacent a bottom of the stem structure; and
an electronics module including a 3D Hall effect sensor disposed in the static stem receiver under the receptacle.

7. The rotary knob control system of claim 1, wherein the sensor system comprises:
a metal pattern disposed at or adjacent a bottom of the stem structure; and
an electronics module including a series of coils disposed in the static stem receiver under the receptacle.

8. The rotary knob control system of claim 1, wherein the static stem receiver comprises a stem receiver structure defining the receptacle, and wherein the stem receiver structure comprises a single unitary molded structure that has no holes or gaskets that allow for water ingress into the sensor system, and wherein the sensor system uses electromagnetic (EM) field coupling to detect a rotation or press, so that a physical interface is not needed, thus eliminating the need for a hole and gasket seal.

9. A rotary knob control system, comprising:
a rotating assembly;
a static stem receiver including a receptacle configured to receive the rotating assembly;
a magnetic suspension system configured to suspend the rotating assembly magnetically within the receptacle without mechanical support and to allow rotational movement of the rotating assembly; and
a sensor system configured to generate electrical signals indicative of position and movement of the rotating assembly within the receptacle.

10. The rotary knob control system of claim 9, wherein the rotating assembly includes a stem structure supported within the receptacle.

11. The rotary knob control system of claim 10, wherein the suspension system includes an inner pair of magnet rings or sets of magnets with specific polarizations housed in the stem structure.

12. The rotary knob control system of claim 11, wherein the suspension system further includes an outer pair of magnetic rings or sets of magnets disposed around outside walls of the receptacle, the first and second pair configured to provide magnetic interaction to maintain separation between the rotating assembly and the static stem receiver.

13. The rotary knob control system of claim 9, further comprising a locking rib mechanism configured to prevent unintentional removal of the rotating assembly from the receptacle.

14. The rotary knob control system of claim 9, wherein the sensor system comprises:
a diametrically polarized magnet disposed at or adjacent a bottom of the stem structure; and
an electronics module including a 3D Hall effect sensor disposed in the static stem receiver under the receptacle.

15. The rotary knob control system of claim 9, wherein the sensor system comprises:
a metal pattern disposed at or adjacent a bottom of the stem structure; and
an electronics module including a series of coils disposed in the static stem receiver under the receptacle.

16. A dual control rotary knob control system, comprising:
a rotating assembly, including an inner knob portion, an outer knob portion;
the inner knob portion including an inner stem structure, the outer knob portion including an outer stem structure, the inner stem structure supporting first and second inner magnetic rings or sets of magnets surrounding a periphery of the inner stem structure, wherein the inner and outer knob portions, and the inner and outer stem structures are formed of a non-magnetic material;
the outer stem structure supporting third and fourth magnetic rings or sets of magnets surrounding a periphery of the outer stem structure;
wherein the third and fourth rings or set of magnets are of opposite polarity as the first and second rings or sets of magnets;
a static stem receiver including a receptacle configured to receive the inner and outer stem structures, and an inner cylindrical structure arranged to fit between the inner and outer stem structures, wherein the static stem receiver is formed of a non-magnetic material;
the inner cylindrical structure of the stem receiver supporting fifth and sixth outer magnetic rings or sets of magnets disposed around the receptacle;
a suspension system configured to suspend the rotating assembly within the receptacle and to allow rotational movement of the rotating assembly; wherein the inner knob portion and the outer knob portion are suspended so that each is rotatable with respect to the other; and
a sensor system configured to generate electrical signals indicative of position and movement of the rotating assembly within the receptacle, the sensor system including a first sensor system to generate electrical signals indicative of position and movement of the inner knob portion, and a second sensor system to generate electrical signals indicative of position and movement of the outer knob portion wherein the sensor system uses electromagnetic (EM) field coupling to detect a rotation or press.

17. The system of claim 16, wherein the first sensor system comprises:
a diametrically polarized magnet disposed at or adjacent a bottom of the stem structure; and
an electronics module including a 3D Hall effect sensor disposed in the static stem receiver under the receptacle.

18. The system of claim 16, wherein the second sensor system comprises:
a metal pattern disposed at or adjacent a bottom of the stem structure; and
an electronics module including a series of coils disposed in the static stem receiver under the receptacle.
